(19) United States
(12) Patent Application Publication
(10) Pub. No.: US 2023/0088229 A1
(43) Pub. Date: Mar. 23, 2023

(54) Peer-To-Peer Borrowing And Lending Systems And Methods

(71) Applicants: Shamari Benton, Southfield, MI (US); Emmanuel Aubrey, Ypsilanti, MI (US)

(72) Inventors: Shamari Benton, Southfield, MI (US); Emmanuel Aubrey, Ypsilanti, MI (US)

(21) Appl. No.: 17/478,543

(22) Filed: Sep. 17, 2021

(51) Int. Cl. G06Q 40/02; G06Q 30/06

(52) U.S. Cl. CPC G06Q 40/025; G06Q 30/0631; G06Q 30/0619

(57) ABSTRACT

Systems and methods for peer-to-peer borrowing and lending platforms are provided, including providing marketplace platforms for, and optional direct linking of, borrowers and lenders for requesting and making loans and entering into transactions.

### FIELD OF THE INVENTION

The invention relates to systems and methods for peer-to-peer borrowing and lending,

### BACKGROUND OF THE INVENTION

Typically, Fintech peer-to-peer lenders seek to participate in relatively large transactions and engage in activities like that of securities brokers. For example, a Fintech entity may raise capital with debt tranches, make government filings (e.g., SEC registrations) and then lend to borrowers depending on various pre-determined risk factors. These Fintech entities charge fees for providing this process and then also service the resulting loans, collecting additional fees for this servicing of the loans. The Fintech entity is thus in several ways primarily a debt service provider.

The middleman role and the methods used of the typical Fintech entity are not particularly efficient and they may not serve to advantageously facilitate the connection of borrowers and lenders. Tools to enable transactions and direct contact between borrowers and lenders, including the execution of promissory notes between the borrower and the lender directly, are often not provided or easily used. Different fee structures also would be useful, including a fee structure that facilitates payment processes instead of principally paying for debt servicing, Improved systems and methods for peer-to-peer lending are thus needed and may provide advantages to borrowers and/or lenders and economic systems alike.

### SUMMARY OF THE INVENTION

This invention provides systems and methods for peer-to-peer borrowing and lending platforms. In preferred embodiments of this invention, members or users of the platforms (e.g., community members, borrowers, lenders) can use such platforms to directly borrow and lend to one another. In these embodiments, the invention provides an open marketplace for borrowing and lending, including, in the most preferred embodiments, for microlending. In alternatives, the platforms of this invention can facilitate parties entering into other transactions besides loans by using the system and methods of this invention.

In certain embodiments, this invention may serve to reduce or eliminate the need of a middleman, such as a typical Fintech entity, in connecting borrowers and lenders and facilitating transactions between them. In certain preferred embodiments, this invention provides tools in the form of modules or components to enable transactions to be negotiated and terms to be set and agreed to directly between borrowers and lenders. In these embodiments, meaningful returns and connections are facilitated between borrowers and lenders.

In certain embodiments, this invention provides for potential borrowers and potential lenders to communicate, negotiate, and edit loan requests and loans. In preferred embodiments, the loan can be processed immediately when the parties come to agreement on the loan terms. In particularly preferred embodiments, loan request offers are set to expire after certain amounts of time (e.g., 24 hours), In certain embodiments the top interest rate a lender can offer is capped (e.g., capped at 30%) and the maximum lending time interval is 9 months.

In preferred embodiments, alternative data on borrowers is used instead of traditional credit metrics. In particularly preferred embodiments, the platforms use presentations in a card like form (e.g., panels) that show, among other things, an overview of the terms of the agreement and the reason why the person needs the loan, a simplified terms statement, a financial overview that shows the users payment history on the platform with a custom grade based on platform use, and the cashflow direction (positive, negative, or neutral) for each month. In particularly preferred embodiments, a profile of potential borrowers is used with social information like education, age, favorite sports teams, etc. Many of the features of these preferred embodiments enable lenders to make decisions concerning loans in untraditional ways.

In preferred embodiments, borrowers that default on loans are locked out of the marketplace until they pay back their loans and successful loans are reported to credit bureaus. Filters are used in preferred embodiments that connect borrowers with lenders in sophisticated ways, such as by zip code, interest rate, due date, grades, stars, loans repaid, categories and annual cash flow direction. In particularly preferred embodiments, borrowers can tag their reason for needing a loan and choose from a list of previously highly used tags. Lenders can then filter by these tags and categories when searching for loans. For example, a lender could search for only medical expenses as a tag or category, In particularly preferred embodiments, a recommendation process is provided that shows future potential loans to lenders.

In certain embodiments, this invention provides a fee structure that facilitates the payment processes associated with borrowing and lending transactions and provides an easier and/or more efficient system for users than aspects of traditional transaction processing by other Fintech entities. The fee structure can be based on when certain events happen, such as when a loan request is entered on the marketplace or made or accepted, or when a promissory note is executed.

The systems and methods of certain embodiments of this invention comprise computer executable instructions available to users from storage media, such as one or more accessible computer servers, over a network, such as a local area network or the internet. The user can access information stored in the storage media, including modules or components that comprise computer executable instructions (e.g., which may include other discrete or overlapping units of executable instructions) that implement the features and/or components of the invention. In certain preferred embodiments the features and/or components of the invention are enabled from a non-transitory computer-readable storage medium comprising stored computer program instructions executable by at least one processor of a system, the instructions, when executed, causing the processor to execute one or more modules or components, each performing one or more functions.

In the most preferred embodiments, a digital promissory note marketplace is provided. Certain embodiments of this invention can provide either a single marketplace or a dual marketplace or both (i.e., a system capable of both). The marketplace can be filtered (i.e., searched and information selected), terms can be negotiated, and users can review profiles to make better informed choices to borrow or lend in the most preferred embodiments.

In a single marketplace, either borrowers or lenders can post offers (e.g., loan requests). The other party in preferred embodiments can then select which offers of those that are posted to examine and consider based on certain filterable criteria. In certain embodiments of a lender's marketplace, offers (e.g., loan requests) from lenders can be examined and considered by potential borrowers. In embodiments of a borrower's marketplace, offers (e.g., loan requests) from borrowers can be examined and considered by potential lenders.

In dual marketplace embodiments, both borrowers and lenders can post offers. The other party can select which offers (e.g., loan requests) of those that are posted to examine and consider based on certain filterable criteria. Thus, borrowers can select which offers from lenders to examine and consider, and lenders can select which offers from borrowers to examine and consider.

In certain embodiments of this invention, whether the marketplace is viewable and/or accessible to the user as a single or dual marketplace can be selected by the user or the system. Thus, in certain embodiments a user can select whether to view and/or access a lender's marketplace, a borrower's marketplace, or a dual marketplace.

In certain embodiments of this invention, potential borrowers and/or potential lenders can compose (e.g., create) and communicate (e.g., post) offers (or requests such as a loan request also referred to as a borrow request). The other party to a potential transaction concerning the offer can then view and access the offer. In preferred embodiments, the offer can be viewed and accessed from a search based on certain filterable criteria (e.g., amount of loan, length of loan, location of loan). In preferred embodiments, the users can set constraints applicable to the offer, such as the amount of time it is open or available for acceptance (e.g., 24 hours).

In certain embodiments of this invention, potential borrowers and/or potential lenders can view and access offers (e.g., requests for loans) and accept the offer as composed. In the most preferred embodiments, potential borrowers and/or potential lenders can view and access offers and further negotiate and edit terms or obtain additional information (e.g., submit counteroffers, present additional terms, request additional information about the borrower or lender, chat on line). In the most preferred embodiments, the parties can make as many iterations of offers and counteroffers as are necessary in order for the parties to come to an agreement or decide not to enter into a transaction.

After the acceptance of an offer as first composed, or later negotiated, the parties can execute a promissory note or other agreement. In preferred embodiments, the execution is done electronically in a manner consistent with general and local rules, laws and regulations so that the note is in full compliance with such rules, laws and regulations and is fully enforceable.

Preferred embodiments of this invention provide a menu-based organization to a promissory note marketplace that enables borrowers and/or lenders to navigate, search for, and select (e.g., filter) potential transactions of interest. In some embodiments, the information available on the marketplace is fully searchable and filterable according to options and/or processes, which can make the platform more efficient, accurate and useful.

In preferred embodiments, the entry of information (e.g., offers, counteroffers, requests for additional information) by the user is automatically edited, and in some embodiments certain minimal terms are suggested and/or required (e.g., amount of loan, length of loan). In certain preferred embodiments, the platform can match offers from potential borrowers and lenders, or otherwise group offers with similar terms (e.g., amount of loan, length of loan), for viewing and access by interested parties. In preferred embodiments, the users can select what information is available to be viewed or it is otherwise limited by the platform (e.g., a potential borrower may be permitted to see only limited information concerning a potential lender or loan requests and the results of negotiations (e.g., a lender's other transactions may not be viewable)).

In preferred embodiments of this invention a recommendation process is provided. These embodiments can take several forms, such as a comment section by other borrowers and/or lenders, a rating system (e.g., use of stars), or other such process for providing additional information to users that may relate to a party's track record, risk factors, or reliability. In preferred embodiments collaborative filtering is performed by the system, such as by using recommendation algorithms that may use artificial intelligence or predictive analysis and formulas.

In certain embodiments of this invention a process for collecting and/or entering data such as with a Profile Module (or first identification information module) is provided. Such a module can be used to input personal information (e.g., address) and financial information (e.g., annual income).

In certain embodiments of this invention a process for making an offer such as with a Loan Request (or Offer) Module (or second loan request module) is provided. Such a module can be used in certain single and/or dual marketplace embodiments. Embodiments of this Loan Request Module can be accessed by borrowers and/or lenders to compose and communicate an offer (e.g., a request for a loan) to potentially interested parties. For example, in some embodiments a potential borrower can use the Loan Request Module to compose and communicate possible terms for a loan to potential lenders. In other embodiments a potential lender can use the Loan Request Module to compose and communicate possible terms for a loan to potential borrowers. In certain embodiments of the Loan Request Module, the other party can request more information concerning the offer or the party that made the offer, which the party that made the offer can consider providing and provide if desired.

In certain embodiments of this invention a process for setting loan terms such as with a Terms (or Edit Terms) Module or modules (a fourth and fifth loan review module) is provided. Embodiments of the Terms Module can be accessed by users interested in either borrowing or lending or both (e.g., in certain single and/or dual marketplace embodiments). The Terms Module in certain embodiments can enable a possible borrower and a possible lender to negotiate and set terms (e.g., amount of loan, timing of loan, interest rates and fees for loan) for promissory notes. In certain embodiments, the Terms Module is available to the user after selecting more information concerning an available offer (e.g., a request for a loan). In the most preferred embodiments, the Terms Module is available to the user after indicating interest in, or otherwise selecting, an offer provided by the Offer Module.

In certain embodiments of this invention processes for searching or filtering information are provided such as with a Filter Module that allows users to search for or filter specific information. Search and filter are terms that are used interchangeability to mean the same thing herein. In certain embodiments of this invention processes for identifying matching or relevant offers and/or requests are provided such as with a Matching Module. Such a module enables the matching of borrower's requests (or offers) with lender's requests (or offers) that are the same or that overlap in the most preferred embodiments.

In certain embodiments of this invention processes for providing a marketplace for loans are provided such as with a Marketplace Module (or third marketplace module). Such a module presents relevant information for those considering borrowing or lending with respect to a loan. In preferred embodiments, the marketplace is searchable for specific information and, in particular, for specific participants based on chosen criteria.

In certain embodiments of this invention a process for accepting an offer (done by a fourth and/or fifth loan review module) and processes for executing a transaction such as with an Execution Module (or sixth promissory note module) is provided. Embodiments of the Execution Module can be accessed by users interested in either borrowing or lending or both (e.g., in certain single and/or dual marketplace embodiments). The Execution Module in certain embodiments can enable a possible borrower and a possible lender to execute or sign a promissory note that was negotiated between the parties.

In preferred embodiments of this invention, processes for the transfer of the loan amount by the lender that accepted a final agreed to offer (e.g., a loan request) to the borrower are provided (a seventh transfer funds module).

In certain embodiments of this invention, methods for diversification of risk are provided that allow for a lender to diversify their investments across several borrowers. In preferred embodiments lenders can select the characteristics of the loans and/or borrowers they use to diversify. In most preferred embodiments lenders can select or otherwise manage the level of risk or the common or mix of characteristics of the loans and/or borrowers for which they wish to engage in by selecting particular characteristics (e.g., amounts of loans, newer borrowers, interest rates) that may be extra conservative, conservative, moderate, aggressive or at other levels of risk.

In certain embodiments of this invention, instead of using the marketplace, or instead of using the marketplace directly, borrowers and/or lenders (and/or the platform) can seek each other out to make direct links and enter into transactions with one another using the processes and data of the marketplace system or using separate processes and data of the platform. In preferred embodiments, the processes and data of the marketplace system are accessed and the system can make recommendations of particular borrowers and/or lenders to contact or otherwise consider. The system can then provide contact and other information to the interested parties and facilitate transactions.

In certain embodiments of this invention, one or more marketplace platforms can be combined to provide a larger or global marketplace platform. In certain of these embodiments, individual Fintech companies can each have their own customizable marketplace platforms of this invention, or different marketplace platforms, and one or more of these marketplace platforms can be combined by this invention and transaction and user data can be shared and transactions be facilitated across the individual marketplace platforms.

### BRIEF DESCRIPTION OF THE DRAWINGS

FIG. 1 is an exemplary screenshot representation of certain create request panel embodiments of the invention.

FIG. 2 is an exemplary screenshot representation of certain loan summary panel embodiments of the invention.

FIG. 3 is an exemplary screenshot representation of certain term panel embodiments of the invention.

FIG. 4 is an exemplary screenshot representation of certain loan details panel embodiments of the invention.

FIG. 5 is an exemplary flowchart that shows, among other things, certain single marketplace embodiments of the invention, wherein in certain of these embodiments possible lenders can locate and examine loan requests from possible borrowers.

FIG. 6 is an exemplary flowchart that shows, among other things, dual marketplace embodiments of the invention, wherein in certain of these embodiments possible lenders can locate and examine loan requests from possible borrowers.

FIG. 7 is an exemplary flowchart that shows, among other things, certain recommendation process embodiments of the invention.

FIG. 8 is an exemplary screenshot representation of certain diversification process embodiments of the invention.

FIG. 9 is an exemplary screenshot representation of certain diversification process embodiments of the invention.

FIG. 10 is an exemplary screenshot representation of certain diversification process embodiments of the invention.

FIG. 11 is an exemplary flowchart that shows, among other things, diversification processes of certain embodiments of the invention.

FIG. 12 is an exemplary screenshot representation of certain direct link lending embodiments of the invention.

FIG. 13 is an exemplary screenshot representation of certain direct link lending embodiments of the invention.

FIG. 14 is an exemplary flowchart that shows, among other things, certain embodiments of direct link lending processes of the invention.

FIG. 15 is an exemplary flowchart that shows, among other things, the creation of a global marketplace platform by the combination of individual customizable marketplace platforms of this invention.

### DETAILED DESCRIPTION OF THE INVENTION

Further descriptions and embodiments of the invention are provided by the following, which can be used to provide systems and methods for peer-to-peer borrowing and lending, where in certain embodiments users can make offers, accept offers, negotiate and propose and set terms for promissory notes using a marketplace. For purposes of description, exemplary discrete panels, modules and embodiments are provided (e.g., named or numbered modules; screenshot representations; geometric shapes in flowcharts with number designations; descriptions of exemplary data, functions and processes). However, the functions, processes and features of some or all of these discrete panels, modules and embodiments can be combined into one or more (or split into fewer) other panels, modules and embodiments, and should not be considered to necessarily limit the description to require separate or combined entities (e.g., panels, modules, embodiments) to perform the functions and processes and obtain the features, benefits and advantages described herein.

Functions, processes and features of this invention include the option of providing one or more interfaces (e.g., panels) for users (borrowers and lenders) to access the system and methods; one or more functions, processes and features of a single marketplace; one or more functions, processes and features of a dual marketplace; one or more functions, processes and features of marketplace recommendations (e.g., borrower ranking); one or more functions, processes and features for diversification of investments and loans; one or more functions, processes and features for direct link lending; one or more functions, processes and features for community group applications; and/or one or more functions, processes and features for making donations. Some or all of these functions, processes and features can be applied in embodiments of this invention.

### Examples Of Borrower Information Or First Identification Information Module Embodiments

In preferred embodiments, borrowers enter personal and financial information using a first identification information module or Profile Module of the system. Personal information can be entered in these embodiments, such as username, gender, marital status, children, education, school, profession, favorite sports team, favorite genre, and linked social media, among other personal information. Financial information can also be entered in these embodiments, such as employment, annual income, homeowner status, housing cost, car payment, among other financial information.

In the most preferred embodiments, a first identification information module (or Profile Module) is provided for a borrower to enter identification information, wherein the identification information comprises name and financial information pertaining to the borrower.

### Examples Of Create Request Or Second Loan Request Module Panel Embodiments

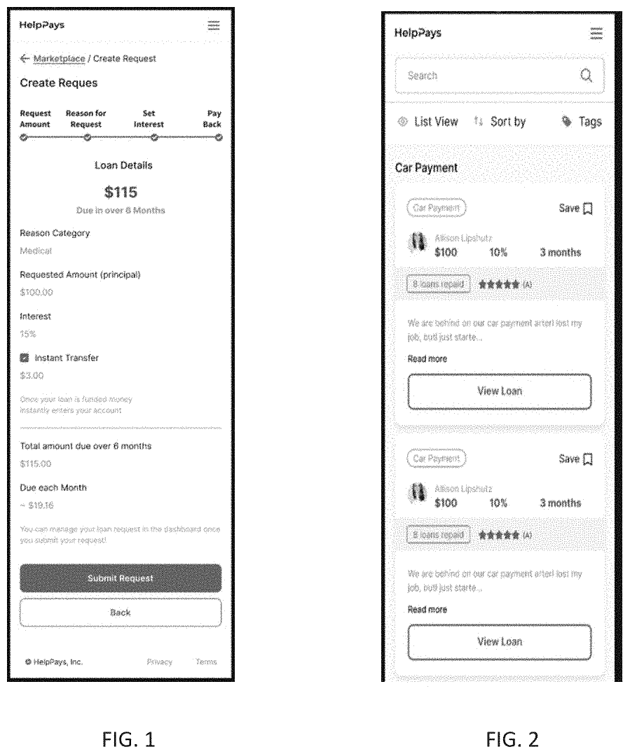

FIG. 1 is a screenshot representation of a Create Request panel from an exemplary HelpPays embodiment of this invention. In this example, a link to the Marketplace panel returns the user back to the Marketplace panel. In the Create Request panel of this embodiment, the user enters information including Request Amount, Reason for Request, Set Interest, and Pay Back. Additional information, or less information, can be required or otherwise provided in other embodiments. When each piece of information is entered, a checkmark is provided in this embodiment so the user can move on to the next task or query. A summary of Loan Details is provided in this embodiment with information indicating when pay back is due. In addition, in this embodiment, the Reason Category (e.g., Medical), the Requested Amount (principal) (e.g., $100.00), the Interest (e.g., 15%), the Total Amount Due Over 6 Months (e.g., $115.00) and the amount Due Each Month (e.g., $19.16) are provided on the panel. In this embodiment, an Instant Transfer box can be checked with a fee amount indicated and when the panel is completed, the user can submit the request by engaging a button.

In the most preferred embodiments, a second loan request module (or Create Request module or panel) is provided for a borrower or a lender to create a loan request, wherein the loan request comprises loan request information including one or more loan terms.

### Examples Of Loan Summary Panel Or Third Marketplace Module Embodiments

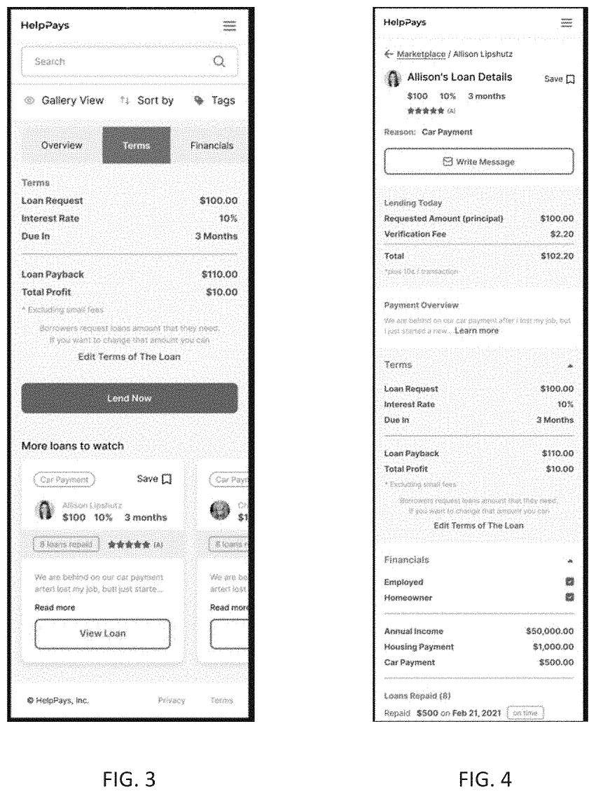

FIG. 2 is a screenshot representation of a Loan Summary panel (or third marketplace module) of an exemplary HelpPays embodiment of this invention, showing a record of loans for a user (e.g., a fictitious user, Allison Lipshutz). The panel in this embodiment includes a summary of the loans, including a star rating system, and other information that may be helpful to a lender. The information in the panel can be listed, sorted and tagged as indicated in this embodiment. Related panels are described as the Terms panel of FIG. 3, and the Loan Details panel of FIG. 4.

In preferred embodiments, a third marketplace module is provided for presenting the identification information and the loan request information. In the most preferred embodiments, a third marketplace module is provided for presenting the identification information, the loan request, a new loan request by any lender or any borrower if any, and a modified loan request by any borrower or any lender if any, to the borrower, other borrowers, the lender or other lenders.

### Examples Of Terms Panel Embodiments

FIG. 3 is a screenshot representation of a Terms panel of an exemplary HelpPays embodiment of this invention, showing the proposed terms of a loan (e.g., Loan Request, Interest Rate, Due In, Loan Payback, Total Profit) entered by a user. In this embodiment, the lender, for example, can edit the terms of the loan offer that were previously entered by a possible borrower. If and when the terms of the loan offer are acceptable to a possible lender and borrower, the lender can execute the loan by engaging a Lend Now button in this embodiment.

FIG. 3 also has more bans to watch that can be selected by the user (e.g., a possible lender), or by the system in certain embodiments. The information in the panel can be listed, sorted, searched and tagged as indicated in this embodiment.

### Examples Of Loan Details Panel Embodiments

FIG. 4 is a screenshot representation of a Loan Details panel of an exemplary HelpPays embodiment of this invention, showing the terms of a ban (e.g., Requested Amount (principal), Verification Fee, Payment Overview, Terms and other). In this embodiment, additional information is provided concerning the borrower, including Financial information (e.g., Employed, Homeowner, Annual Income, Housing Payment, Car Payment, loan payment record (e.g., Loans Repaid)).

### Examples Of Single Marketplace Embodiments

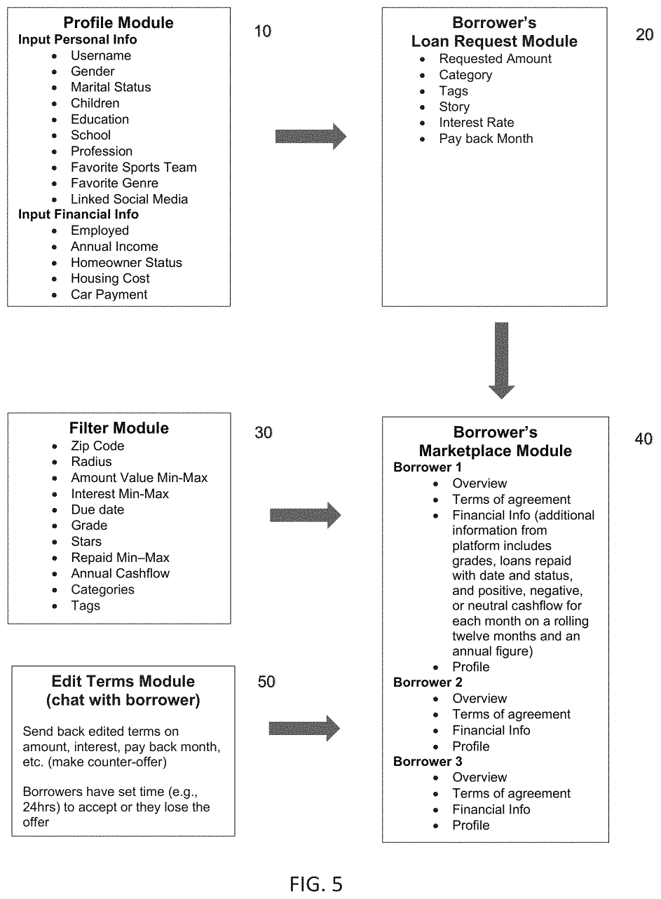

FIG. 5 is an exemplary flowchart for certain single marketplace embodiments of the invention. Borrowers enter personal and financial information using a Profile Module 10 (or first identification information module) of the system. Personal information can be entered in this embodiment, such as username, gender, marital status, children, education, school, profession, favorite sports team, favorite genre, and linked social media, among other personal information. Financial information can also be entered in this embodiment, such as employment, annual income, homeowner status, housing cost, car payment, among other financial information.

In the embodiments of FIG. 5, after the Profile Module 10, the borrower is directed to a Loan Request Module 20 (or second loan request module) where loan information for the loan desired by the borrower is entered. This information can include a variety of information that a possible lender would be interested in learning, as well as information a borrower would be interested in providing, for example. It could include the requested amount, the category or type of loan, various tags, the reason for the loan or the story that applies, the interest rate and the pay back month, among other information.

In the embodiments of FIG. 5, after the Loan Request Module 20 is completed, the information that has been input is directed to a Marketplace Module 40 (or third marketplace module) that is accessible to lenders, and in preferred embodiments, borrowers are not permitted full access to all of the information it contains or may have variable degrees of access. The Marketplace Module 40 can present the information for one or more borrowers and preferably many borrowers. The information for each borrower can include the general terms desired by the borrower for the loan, an overview of the transaction, additional financial information (e.g., grades, loans repaid with date and status information, positive, negative or neutral cashflow for each month on a rolling twelve-month basis and an annual figure), and profile information concerning the borrower. The same information categories can also be provided for one or more other borrowers also so that a single possible lender can examine, consider and choose among the different transactions from the different borrowers.

In the embodiments of FIG. 5, a Filter Module 30 can be used by a lender to search for and select particular borrowers and/or transactions to examine, consider and negotiate, for example, from the Marketplace Module 40. Thus, the Filter Module 30 can arrange or search for particular borrowers and/or transactions by categories such as zip code, distance or radius, amount of value (e.g., setting minimums and/or maximums), interest rates (e.g., setting minimums and/or maximums), due date, grade, stars or a review/recommendation system, loans repaid (e.g., setting minimums and/or maximums), annual cashflow, categories, tags, and other characteristics.

In the embodiments of FIG. 5, an Edit Terms Module 50 (or fourth and fifth loan review modules) can be used by lenders to negotiate, counteroffer, and send the borrower revised terms on the loan amount, interest, pay back month, etc., which is presented on the Marketplace Module 40. Thus, the Edit Terms Module 50 can permit possible lenders and possible borrowers to negotiate the terms of the loan. The Edit Terms Module 50 can be used to set time limits on how long a party (e.g., borrower) can consider an offer or counter coffer before it expires.

In the most preferred embodiments, a fourth and fifth loan review module are provided. The fourth loan review module provides for any lenders or any borrowers to accept or request modification of the loan request, wherein if there is a request for modification of the loan request it results in a new loan request by any lender or any borrower. The fifth loan review module provides for any borrower or any lenders to accept, deny or request modification of any new loan request by the lender or the borrower, wherein if there is a request for modification of the new loan request by any lender or any borrower it results in a modified loan request by any borrower or any lender.

### Examples Of Dual Marketplace Embodiments

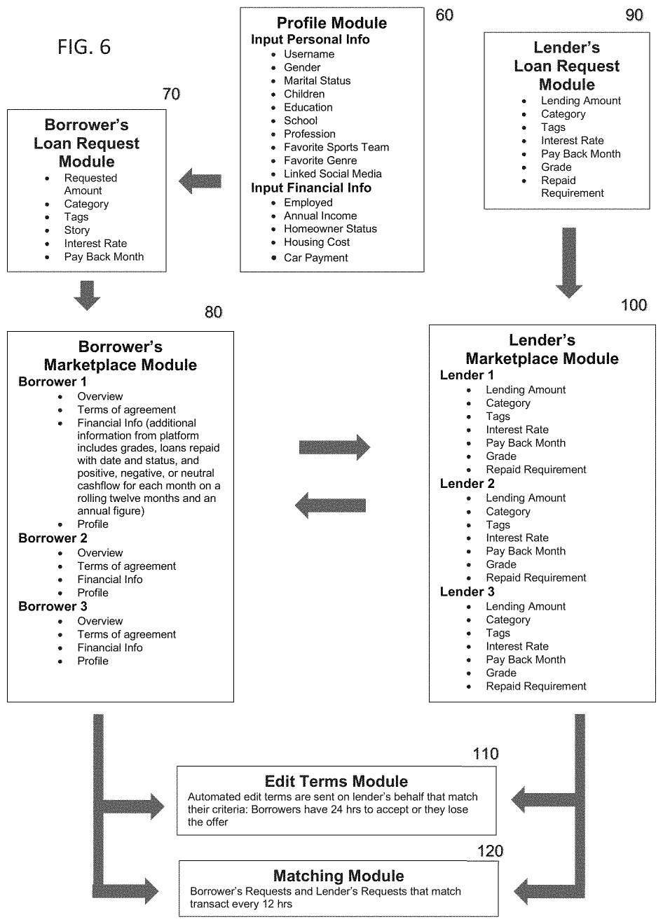

FIG. 6 is an exemplary flowchart for certain dual marketplace embodiments of the invention. Borrowers enter personal and financial information using a Profile Module 60 (or first identification information module) of the system. Personal information can be entered in this embodiment, such as username, gender, marital status, children, education, school, profession, favorite sports team, favorite genre, and linked social media, among other personal information. Financial information can also be entered in this embodiment, such as employment, annual income, homeowner status, housing cost, car payment, among other financial information. In certain embodiments of dual marketplace embodiments, a similar module (not shown) is provided for lenders to enter their relevant information into the system.

In the embodiments of FIG. 6, after the Profile Module 60, the borrower is directed to a Borrower's Loan Request Module 70 (or second loan request module) where loan information for the loan desired by the borrower is entered. This information can include a variety of information that a possible lender would be interested in learning, as well as information a borrower would be interested in providing, for example. It could include the requested amount, the category or type of loan, various tags, the reason for the loan or the story that applies, the interest rate and the pay back month, among other information.

In the embodiments of FIG. 6, after the Borrower Loan Request Module 70 is completed, the information that has been input is directed to a Borrower's Marketplace Module 80 (or third marketplace module) that is accessible to lenders, and in preferred embodiments, borrowers are not permitted access or may have variable degrees of access. The Borrower's Marketplace Module 80 can present the information for one or more borrowers and preferably many borrowers. The information for each borrower can include the general terms desired by the borrower for the loan, an overview of the transaction, additional financial information (e.g., grades, loans repaid with date and status information, positive, negative or neutral cashflow for each month on a rolling twelve-month basis and an annual figure), and profile information concerning the borrower. The same information categories can also be provided for one or more other borrowers also so that a single possible lender can examine, consider and choose among the different transactions from the different borrowers.

In the embodiments of FIG. 6, after entering identification information or referring to previously entered user information, a possible lender is directed to a Lender's Loan Request Module 90 (or second loan request module) where loan information for the loan desired by the lender is entered. This information can include a variety of information that a possible borrower would be interested in learning, as well as information a lender would be interested in providing, for example. It could include the lending amount, the category or type of loan, various tags, the interest rate, the pay back month, the grade of the loan, or other requirement for borrowers to meet, and any repaid requirements, among other information.

In the embodiments of FIG. 6, after the Lender's Loan Request Module 90 is completed, the information that has been input is directed to a Lender's Marketplace Module 100 that is accessible to borrowers, and in certain preferred embodiments, lenders are not permitted access or may have variable degrees of access. The Lender's Marketplace Module 100 (or third marketplace module) can present the information for one or more lenders and preferably many lenders. The information for each lender can include the general terms desired by the lender for the loan, the lending amount, the category or type of the loan, any tags that apply or are useful, the interest rate, the pay back month, the grade of the loan, or other requirements for the borrowers to meet, any repaid requirements, among other information. The same information categories can also be provided for one or more other lenders also so that a single possible borrower can examine, consider and choose among the different transactions from the different lenders.

In the embodiments of FIG. 6, a Matching Module 120 can be used by the system to search and select particular borrowers, lenders and/or transactions to examine, consider and negotiate, for example, from the Borrower's Marketplace Module 80 and/or the Lender's Marketplace Module 100. Thus, in certain embodiments, the Matching Module 120 can arrange or search for particular borrowers, lenders and/or transactions by categories such as zip code, distance or radius, amount of value (e.g., setting minimums and/or maximums), interest rates (e.g., setting minimums and/or maximums), due date, grade, stars or a review/recommendation system, loans repaid (e.g., setting minimums and/or maximums), annual cashflow, categories, tags, and other characteristics. In alternative embodiments, the Matching Module serves to search for and filter the available borrowers and their terms using criteria selected by the lender, in a manner similar to the Filter Module 30 of FIG. 5. In particularly preferred embodiments, exact matches between the borrowers' loan requests in the borrower's marketplace and the lenders' loan requests in the lender's marketplace are transacted on a timely basis.

In certain embodiments of FIG. 6, an Edit Terms Module 110 (or fourth loan review module and fifth loan review module) can be used by the system that sends, on the lender's behalf, and according to the lender's selected criteria, automated edit terms to possible borrowers, who then may have a set time (e.g., 12 hours) for the borrower to accept the terms or lose the offer. In alternative embodiments, an Edit Terms Module can be used by lenders to negotiate, counteroffer, and send the borrower revised terms on the loan amount, interest, pay back month, etc., which is presented on the Lender's Marketplace Module 100. In certain embodiments, an Edit Terms Module can be used by borrowers to negotiate, counteroffer, and send the lender revised terms on the loan amount, interest, pay back month, etc., which is presented on the Borrower's Marketplace Module 80. Thus, the Edit Terms Module 110 can permit possible lenders and possible borrowers to negotiate the terms of the loan. The Edit Terms Module 110 can be used to set time limits on how long a party (e.g., borrower) can consider an offer or counteroffer before it expires.

In preferred embodiments of FIG. 6, lenders can search the Borrower's Marketplace Module 80 for potential borrowers to engage. In this way the system creates a lender's marketplace to lend money.

### Examples Of Recommendation Embodiments

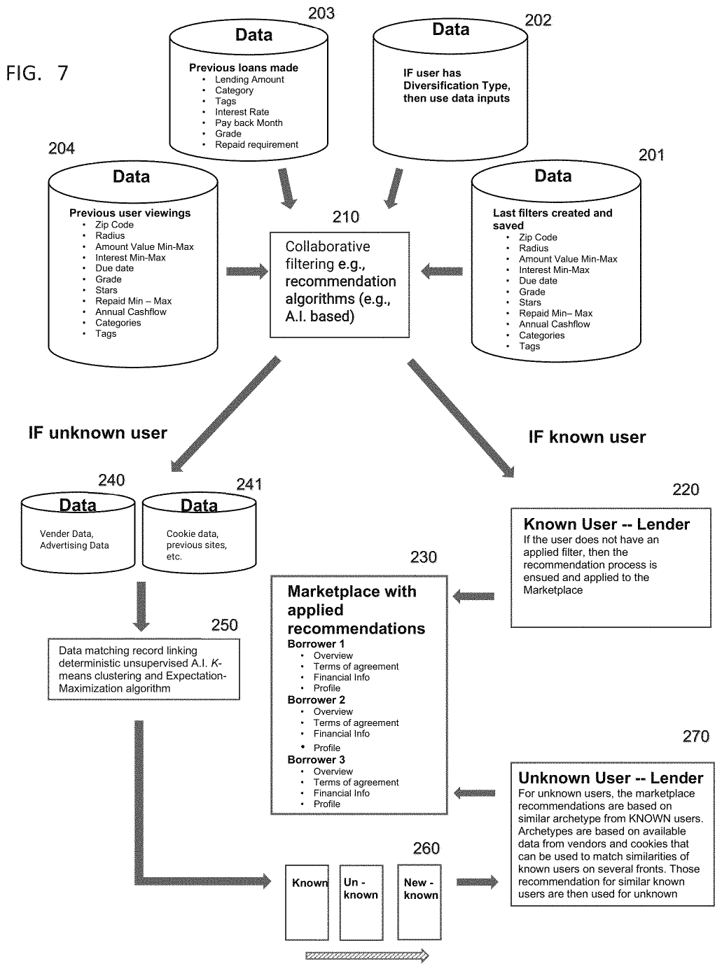

FIG. 7 is an exemplary flowchart for certain recommendation process embodiments of the invention, Data concerning possible borrowers (e.g., “users” here) from various sources 201, 202, 203, 204 is processed by collaborative filtering 210 using, for example, recommendation algorithms (e.g., artificial intelligence based) and/or other decision-making processes known to a person skilled in the art. In the embodiments shown in FIG. 7 a different path is then taken for the known user as opposed to the unknown user (e.g., known to the system).

In certain of the embodiments of FIG. 7, once the recommendation process has begun and been processed by collaborative filtering 210, for example, if the user is a known user to the system, then further filters are not applied and the recommendation process with data concerning the known user ensues and is applied 220 in a Marketplace with applied recommendations 230.

If, instead, the user is unknown, then in certain embodiments data is applied (e.g., vender data, advertising data 240 and/or cookie data, previous sites, etc. 241) along with data matching record linking with, for example, deterministic unsupervised A.I. Clustering performance comparisons can be made in certain embodiments using K-means and expectation-maximization algorithms 250 and comparisons are made of and processes applied to known, un-known and new-known subject data 260.

For example, in certain embodiments for unknown users, marketplace recommendations are based on similar archetypes from known users 270. Archetypes are based on available data from, for example, vendors 240 and cookies 241 that can be used to match similarities of known users on several fronts 250 260. Those recommendations for similar known users are then used for unknown users 270 for the Marketplace with applied recommendations 230.

### Examples Of Diversification Embodiments

Certain Diversification embodiments of this invention have advantages and/or one or more features that can be similar to those from index fund investing. For example, in certain HelpPays embodiments with one or more of these features, the system provides pre-made filters on investment criteria that lenders can choose based on their risk tolerance. With a many-to-many relationship no one user will make up more than, for example, a certain percentage (e.g., 10%) of a loan amount.

After selecting a fund type in certain of these embodiments, the lender then makes a series of choices. First, in certain embodiments, the lender chooses an initial amount to be invested and a monthly reoccurring option with the corresponding amount. Second, in certain of these embodiments, the lender chooses whether they want to stay invested or choose a month in which they want all funds to begin a redeeming process. Alternatively, the lender can diversify across different loan types or other criteria of the loans (e.g., borrower's age or occupation; borrower's rankings; interest rates; loan amounts).

Potential advantages of certain of these embodiments can be that they are effectively a novel many-to-many promissory note system (e.g., a many-to-many digital promissory note system). These features of these embodiments can be combined with other functions and processes of this invention, including matching and/or editing of terms to match selected critera; processes for applying diversification; processes for redeeming funds; redemption processes (e.g., using an optimization algorithm); and automated editing with diversification criteria, as exemplified further below.

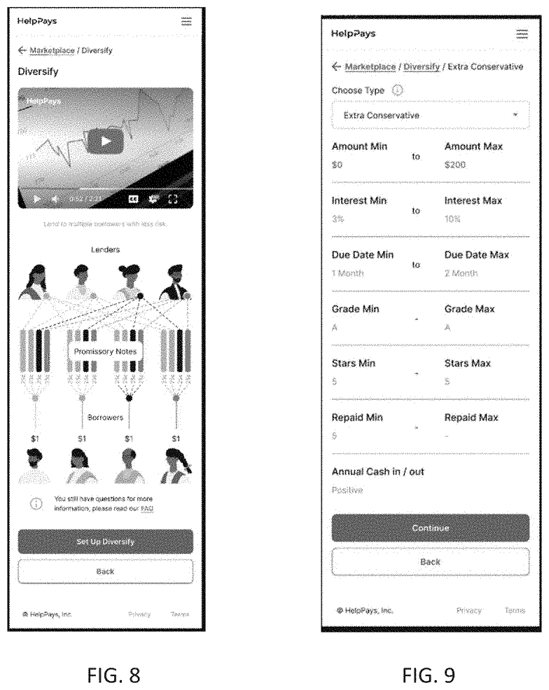

FIG. 8 is a screenshot representation of a Marketplace/Diversify panel from exemplary HelpPays embodiments of this invention. The panel of this embodiment has an informational video that a lender can choose that explains the concepts of diversification of risk, and specifically how to lend to multiple borrowers and potentially reduce risk. The lender can also choose to obtain more information by selecting a FAQ link that is provided in this embodiment. If the lender chooses to diversify, the next step in these embodiments is to toggle a “Set Up Diversify” button, which sends the user to the next panel, shown in FIG. 9.

FIG. 9 is a screenshot representation of a panel from exemplary HelpPays embodiments of this invention that assists the user in setting up a diversified loan position. In this example of an embodiment, the user can select how aggressive to invest or loan (e.g., “Extra Conservative” which selects for low-risk characteristics, such as low amounts to loan, high interest, high grades, high ratings, etc.) the range to invest or loan. The range of amounts to invest or loan, the range of interest rates to charge, the range of due dates, the range of grades, the range of ratings values such as stars, and the range of repaid amount, can all be set in this particular example of FIG. 9. Other features can be added such as a computation for the user of “Annual Cash in/out” can be provided before, in this example, the user selects a “Continue” or “Back” button.

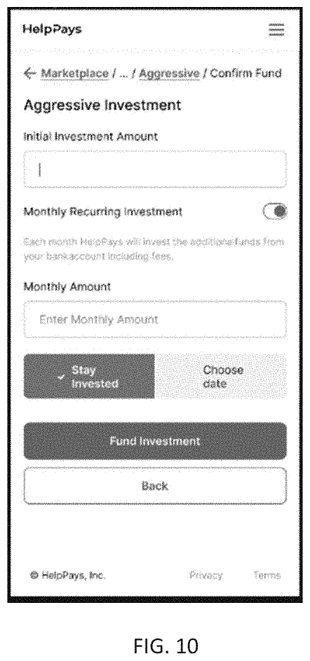

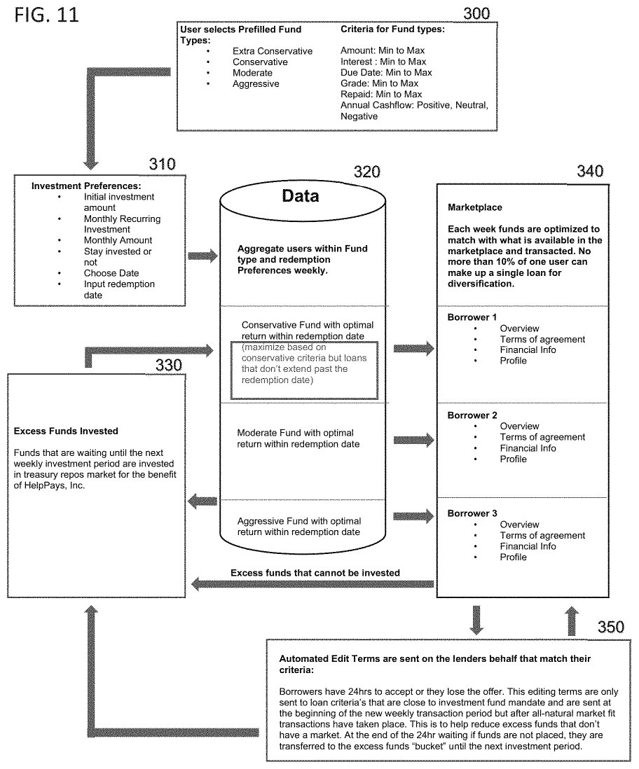

FIG. 10 is another screenshot representation of a panel from exemplary HelpPays embodiments of this invention that will confirm information for the user (e.g., “Confirm Fund”). In this example, an “Aggressive Investment” was chosen by the user, who can enter an Initial Investment Amount and Monthly Amount, and also choose whether it is a Monthly Recurring Investment in which the system will invest additional funds from the user's bank account (including fees) each month. The user can then select to Stay Invested or Choose date to make an investment. When complete, in this example, the user can select a “Fund Investment” or “Back” button and therefore either fund the loans in the manner selected or return back to prior screens.

FIG. 11 is an exemplary flowchart showing diversification processes of certain embodiments of the invention. In certain of these embodiments, the user selects prefilled fund types (e.g., extra conservative, conservative, moderate, aggressive) based on one or more criteria (e.g., amount of loan, interest, due date, grade, repaid amount, annual cashflow, neutral) 300. The user then selects investment preferences (e.g., amount of initial investment, whether monthly recurring investment, monthly amounts, whether to stay invested, choose dates, input redemption dates) 310. The system then accesses, at set intervals in some embodiments (e.g., weekly), data 320, including aggregate data of users within fund types and redemption preferences. This data includes in some embodiments data corresponding to conservative funds (with optimal returns within selected redemption dates) that are maximized based on selected criteria but which do not extend past their redemption dates, moderate funds (with optimal returns within selected redemption dates), and aggressive funds (with optimal returns within selected redemption dates, as possible examples.

In certain embodiments, the system then accesses a Marketplace 340, which in the embodiments of FIG. 11 optimize funds each week (or other time interval) to match transactions that are available in the marketplace of one or more borrowers within optional limits (e.g., no more than 10% of one user can make up a single loan for diversification purposes). The system in some embodiments can transfer excess funds from the Marketplace 340, which funds cannot be invested, to other funds 330 that are waiting to be invested until the next investment period. These latter funds 330 can be invested in treasury repo markets or other vehicles for the benefit of the system (e.g., HelpPays embodiments).

In certain embodiments, the Marketplace 340 interacts with Automated Edit Terms functions and processes 350, which in the embodiments of FIG. 11 are sent on the lenders behalf and they match their selected criteria. In certain of these embodiments, borrowers have a set time (e.g., 24 hours) to accept or they lose the offer. These Automated Edit Terms 350 are only sent if they relate to the loan criteria that are close to the type of investment fund mandate chosen, and in certain embodiments they are sent at the beginning of the new transaction period (e.g., weekly) but after all-natural market fit transactions have taken place. In short, this is to help reduce the amount of excess funds that do not have an adequate market. At the end of the waiting period (e.g., 24 hours), if funds are not placed, they are transferred to the excess funds “bucket” 330 until the next investment period.

### Examples Of Direct Link Lending Embodiments

Direct link lending embodiments can be configured to provide the ability to lend or borrow directly between individuals and bypass the marketplace. In certain of these embodiments, users input information (e.g., the recipient's email address), a username, telephone number or other identification information to send a digital promissory note card that can be edited. The digital promissory note will contain, for example, useful information such as the amount, interest rate, due date, category and a short message. Additionally, if the intent of the message is for the sender to become a borrower, the lender will see the additional information from the borrower that is stored in the system (e.g., HelpPays embodiments). Recipients can either accept or deny such. Potential advantages and/or features of such direct link lending embodiments can include, if so desired, digital promissory notes that can be edited, accepted or denied; encrypted hyperlinks that connect digital promissory notes that can be edited, accepted or denied; and/or information on previous connections recommendations.

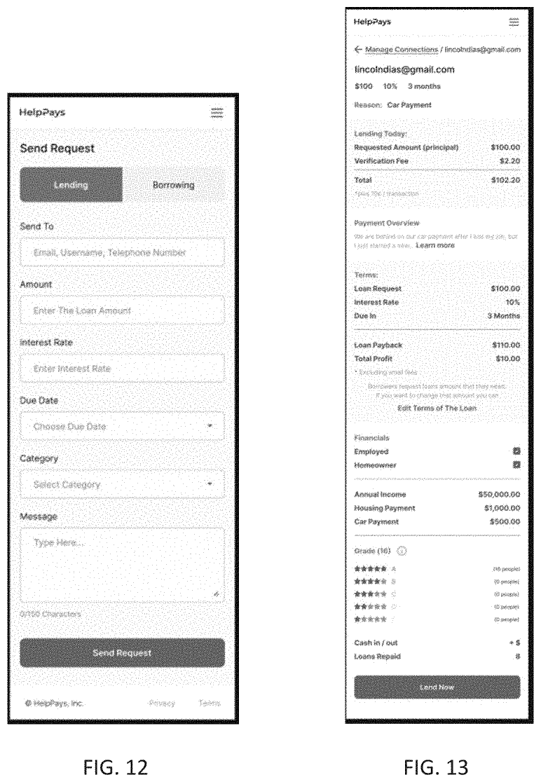

FIG. 12 is an exemplary screenshot representation of certain direct link lending embodiments of the invention with a provision for a send request and where the user selects either a lending or a borrowing button. In this embodiment, the user provides information to send in the request, such as, for example, the amount of the loan, interest rate, due date, category, and a provision for providing a message, as examples. When the information is complete, the user can engage the send request button in FIG. 12. FIG. 13 is an exemplary screenshot representation of the information a user might provide to a lender (e.g., email address, loan amount, interest rate, due date, financials, grade, etc.) and if the lender approves, the lender can engage the lend now button and make the loan.

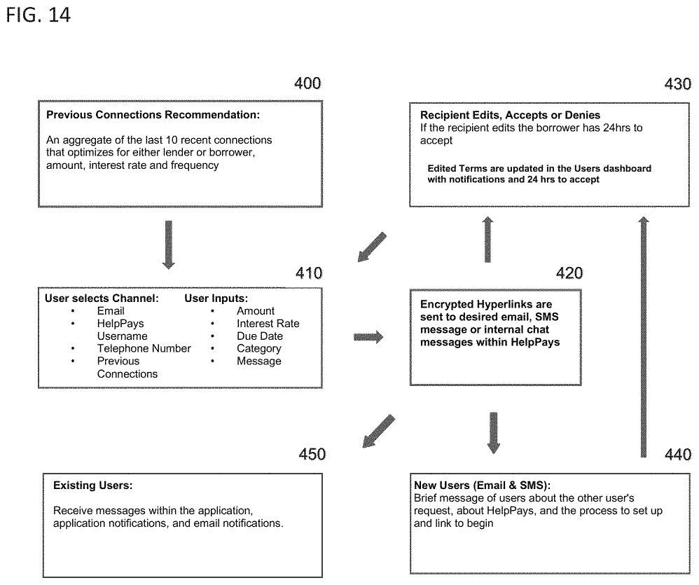

FIG. 14 is an exemplary flowchart that shows, among other things, certain embodiments of direct link lending processes of the invention. In certain of these embodiments, a recommendation is made by the system based on previous connections 400, and in this example, it is an aggregate of the last 10 most recent connections that is optimized for either lender or borrower, amount, interest rate and/or frequency. The user then selects the desired channel (e.g., email, HelpPays or other system username, telephone number, previous connections, etc.) and inputs relevant information (e.g., amount, interest rate, due date, category, message to other party) 410. In the next step of certain of these embodiments 420, encrypted hyperlinks are sent to desired emails, SMS message addresses or internal chat message addresses within the system (e.g., HelpPays embodiments). Existing users 450 in certain embodiments receive messages within the application, application notifications and/or email notifications. New users (via, for example email and/or SMS) in certain embodiments receive a brief message from the users about the other user's request, information about HelpPays or other system, and the process to set up and a link to begin 440.

In FIG. 14, the recipient of the information on the loan then edits, accepts or denies the loan 430. If the recipient is a lender that edits the loan, the borrower has 24 hours to accept. Edited Terms are updated on the user's dashboard 410 (e.g., “User Inputs”) with notifications and 24 hours to accept.

### Examples Of Community Group And Peer-To-Peer API Lending And Borrowing Embodiments

In certain embodiments of the invention, provisions are made to create new public or private groups for lending and borrowing with systems, such as HelpPays embodiments. In certain of these embodiments, invitations can be sent to members by in app messages, email, SMS or pass code. For public groups, anyone can create a group and join a group by sending a request. One member already in the group must accept a request for new members to join the group. For private groups, members must have a pass code or invitations must be sent to the individuals directly. Once the group is set up, in certain of these embodiments, individuals in a particular group can post anonymous or open borrower requests and only the members of that group can see the requests. Groups can range from companies, to religious groups, to family networks or causes like breast cancer, burned down homes or domestic violence, etc. Anyone can create a group and only public groups are searchable to join (i.e., priviate groups can also be created but cannot be searched by the general public). Members can post comments, share information about causes, and otherwise interact.

In certain of these community group embodiments, the group is provided embodiments of the recommendation process described above. This process can be based on categories and tags can be viewed, notes can be funded and previous groups can be selected. The advantages and/or functions of certain of these community group embodiments include the creation of a public or private marketplace for promissory notes and preferably with selected or otherwise vetted members.

In certain of these community group embodiments, lenders can choose to donate funds to borrowers at any time during the loan. If loans are donated, then lenders are transferred to a 501(c)(3) entity and they receive tax write-offs. In other embodiments, default loans can be changed to donated funds. In other embodiments, verbiage can be added to a promissory notes to create unique and specific contracts that can be executed digitally with the click of a button.

In certain of these community group embodiments, peer-to-peer application programming interface (API) is applied to create an API key exchange that allows peer-to-peer marketplaces to be easily constructed customizable marketplaces for other Fintech companies and it allows borrowers and lenders to appear in all (or more than one) marketplaces at once. The corresponding Fintech companies will receive payments if their user's transaction is tethered in a marketplace. Systems such as HelpPays embodiments will collect a fee on every transaction made in certain of these embodiments. In certain embodiments, default users are banned from all marketplaces until they payback the loan. In particularly preferred embodiments, a global marketplace is provided that allows companies and other entities to plug into the platforms' API to set up a marketplace of their own. In preferred embodiments, borrowers and lenders are shown globally on all platforms through the API.

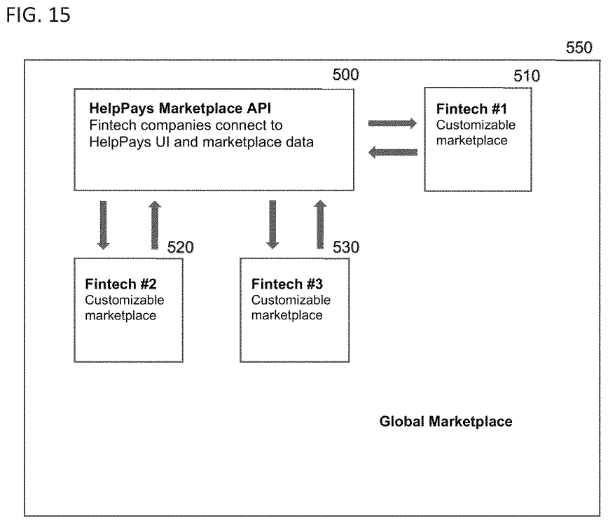

FIG. 15 is an exemplary flowchart that shows, among other things, embodiments of a Peer-to-Peer Application Programming Interface (API) of the invention. In these HelpPays examples of embodiments, a global marketplace 550 is created where borrowers and lenders are shown in all (or more than one) of the marketplaces. Fintech companies earn when their users make transactions. Systems such as HelpPays collect fees on all or at least some transactions. Thus, in certain of these embodiments, the HelpPays Marketplace API 500 is used by Fintech companies to connect to HelpPays' user interface (UI) and marketplace data. The marketplaces of three other Fintech companies 510, 520, 530 are shown in the example of FIG. 15 connecting and otherwise interacting with the HelpPays Marketplace API 500.

The subject matter of this disclosure is now described with reference to the following Examples. These Examples are prospective examples provided for the purpose of illustration only, and the subject matter is not limited to these Examples, but rather encompasses all variations which are evident as a result of the teaching provided herein.

### EXAMPLE 1

This example describes a peer-to-peer borrowing and lending lender's marketplace platform comprising seven modules (or groups of functions, processes or features) that can each be combined with other modules or separated into additional modules. The first identification information module provides for a borrower to enter identification information, wherein the identification information comprises name and financial information pertaining to the borrower. The second loan request module provides for a lender to create a loan request, wherein the loan request comprises loan request information including one or more loan terms.

The third marketplace module provides for presenting the identification information, the loan request information, a new loan request by a borrower if any, and/or a modified loan request by the lender if any, to the lender, other lenders, the borrower and other borrowers. In effect, this module provides key elements of a marketplace for the participants.

The fourth loan review module provides for the borrower or other borrowers to accept or request modification of the loan request, wherein if there is a request for modification of the loan request it results in a new loan request by a borrower. The fifth loan review module provides for the lender to accept or request modification of any new loan request by a borrower, wherein if there is a request for modification of the new loan request by a lender it results in a modified loan request by the lender. There can be multiple iterations of these events provided for by the fourth and fifth loan review modules until a deal is reached or the parties decline further actions on the loan request. The fourth and the fifth loan review modules therefore affect the negotiation of the loan terms.

The sixth promissory note module provides for the creation of a promissory note for loan requests, new loan requests by a borrower, and modified loan requests by the lender that have been accepted by the borrower or one of the other borrowers and the lender. The seventh transfer funds module provides for the transfer of the loan amount from the lender and the borrower that accepted with respect to the sixth promissory note module.

In addition to the above, the peer-to-peer borrowing and lending lender's marketplace platform can provide for the third marketplace module filtering by the lenders for types of identification information and/or loan request information. The platform can also provide for the third marketplace module filtering the information shown to the borrower concerning the lenders.

The platform can also be configured to filter loan requests for selected and/or overlapping loan request information to aid the users. The platform may also filter borrower information comprising identification information from the borrower and/or other borrowers that has been processed through a predictive algorithm to make a recommendation as to the borrower's fitness (e.g., ability to repay or reliability) for a loan. The platform can also be configured to provide for multiple lenders to each accept a portion of the loan requests, enter into promissory notes, and transfer a portion of loan amounts so that each of the lenders do not take on all of the risk of the borrower defaulting on the loan.

The platform can also be configured to provides for a lender to filter for particular identification information and/or loan request information and make multiple loans across multiple borrowers to diversify the lender's risk of borrowers defaulting on their loans. The platform can also be configured to provide for the third marketplace module to be bypassed and instead the platform directly links the borrower and the lender, or, alternatively, the borrower and/or the lender bypass the third marketplace module and instead use the platform to directly link the borrower and the lender.

The platform can be configured to be publicly available to any groups, networks, borrower and/or lender on the internet, or, alternatively, it can be configured to be only privately available to groups, networks, borrowers and/or lenders by invitation only.

In alternative configurations, multiple platforms of this Example are connected and identification information and loan request information are shared across the multiple platforms. In addition, the platform can be configured to facilitate the conversion of a defaulted loan to a charitable donation for the benefit of the lender(s) that accepted with respect to the seventh transfer funds module.

### EXAMPLE 2

This example describes a peer-to-peer borrowing and lending borrower's and lender's marketplace platform comprising seven modules (or groups of functions, processes or features) that can each be combined with other modules or separated into additional modules. The first identification information module provides for a borrower to enter identification information, wherein the identification information comprises name and financial information pertaining to the borrower. The second loan request module provides for the borrower or a lender to create a loan request, wherein the loan request comprises loan request information including one or more loan terms.

The third marketplace module provides for presenting the identification information, the loan request information, a new loan request by any lender or any borrower if any, and/or a modified loan request by any borrower or any lender if any, to the borrower, other borrowers, the lender or other lenders. In effect, this module provides key elements of a marketplace for the participants.

The fourth ban review module provides for any lenders or any borrowers to accept or request modification of the ban request, wherein if there is a request for modification of the ban request it results in a new ban request by any lender or any borrower. The fifth ban review module provides for any borrower or any lenders to accept, deny or request modification of any new ban request by the lender or the borrower, wherein if there is a request for modification of the new ban request by any lender or any borrower it results in a modified ban request by any borrower or any lender. There can be multiple iterations of these events provided for by the fourth and fifth ban review modules until a deal is reached or the parties decline further actions on the loan request. The fourth and the fifth loan review modules therefore affect the negotiation of the loan terms.

The sixth promissory note module provides for the creation of a promissory note for loan requests, new loan requests by any lender or any borrower, and modified loan requests by any borrower or any lenders that have been accepted by any borrower and one or more lenders. The seventh transfer funds module provides for the transfer of the loan amount from the lender and the borrower that accepted with respect to the sixth promissory note module.

In addition to the above, the peer-to-peer borrowing and lending borrower's and lender's marketplace platform can provide for the third marketplace module filtering by the lenders for types of identification information and/or loan request information. The platform can also provide for the third marketplace module filtering the information shown to the borrower concerning the lenders.

The platform can also be configured to filter loan requests for selected and/or overlapping loan request information to aid the users. The platform may also filter borrower information comprising identification information from the borrower and/or other borrowers that has been processed through a predictive algorithm to make a recommendation as to the borrowers fitness (e.g., ability to repay or reliability) for a loan. The platform can also be configured to provide for multiple lenders to each accept a portion of the loan requests, enter into promissory notes, and transfer a portion of loan amounts so that each of the lenders do not take on all of the risk of the borrower defaulting on the loan.

The platform can also be configured to provides for a lender to filter for particular identification information and/or loan request information and make multiple loans across multiple borrowers to diversify the lender's risk of borrowers defaulting on their loans. The platform can also be configured to provide for the third marketplace module to be bypassed and instead the platform directly links the borrower and the lender, or, alternatively, the borrower and/or the lender bypass the third marketplace module and instead use the platform to directly link the borrower and the lender.

The platform can be configured to be publicly available to any groups, networks, borrower and/or lender on the internet, or, alternatively, it can be configured to be only privately available to groups, networks, borrowers and/or lenders by invitation only.

In alternative configurations, multiple platforms of this Example are connected and identification information and loan request information are shared across the multiple platforms. In addition, the platform can be configured to facilitate the conversion of a defaulted loan to a charitable donation for the benefit of the lender(s) that accepted with respect to the seventh transfer funds module.

### EXAMPLE 3

This example describes a peer-to-peer borrowing and lending borrower's marketplace platform comprising seven modules (or groups of functions, processes or features) that can each be combined with other modules or separated into additional modules. The first identification information module provides for a borrower to enter identification information, wherein the identification information comprises name and financial information pertaining to the borrower. The second loan request module provides for the borrower to create a loan request, wherein the loan request comprises loan request information including one or more loan terms.

The third marketplace module provides for presenting the identification information, the loan request information, a new loan request by a lender if any, and/or a modified loan request by the borrower if any, to one or more lenders. In effect, this module provides key elements of a marketplace for the participants.

The fourth ban review module provides for the one or more lenders to accept or request modification of the ban request, wherein if there is a request for modification of the ban request it results in a new ban request by a lender. The fifth ban review module provides for the borrower to accept or request modification of any new loan request by a lender, wherein if there is a request for modification of the new loan request by a lender it results in a modified loan request by the borrower. There can be multiple iterations of these events provided for by the fourth and fifth loan review modules until a deal is reached or the parties decline further actions on the loan request. The fourth and the fifth loan review modules therefore affect the negotiation of the loan terms.

The sixth promissory note module provides for the creation of a promissory note for loan requests, new loan requests by a lender, and modified loan requests by the borrower that have been accepted by the borrower and at least one lender. The seventh transfer funds module provides for the transfer of the loan amount from the lender and the borrower that accepted with respect to the sixth promissory note module.

In addition to the above, the peer-to-peer borrowing and lending borrower's and lender's marketplace platform can provide for the third marketplace module filtering by the lenders for types of identification information and/or loan request information. The platform can also provide for the third marketplace module filtering the information shown to the borrower concerning the lenders.

The platform can also be configured to filter loan requests for selected and/or overlapping loan request information to aid the users. The platform may also filter borrower information comprising identification information from the borrower and/or other borrowers that has been processed through a predictive algorithm to make a recommendation as to the borrower's fitness (e.g., ability to repay or reliability) for a loan. The platform can also be configured to provide for multiple lenders to each accept a portion of the loan requests, enter into promissory notes, and transfer a portion of loan amounts so that each of the lenders do not take on all of the risk of the borrower defaulting on the loan.

The platform can also be configured to provides for a lender to filter for particular identification information and/or loan request information and make multiple loans across multiple borrowers to diversify the lender's risk of borrowers defaulting on their loans. The platform can also be configured to provide for the third marketplace module to be bypassed and instead the platform directly links the borrower and the lender, or, alternatively, the borrower and/or the lender bypass the third marketplace module and instead use the platform to directly link the borrower and the lender.

The platform can be configured to be publicly available to any groups, networks, borrower and/or lender on the internet, or, alternatively, it can be configured to be only privately available to groups, networks, borrowers and/or lenders by invitation only.

In alternative configurations, multiple platforms of this Example are connected and identification information and ban request information are shared across the multiple platforms. In addition, the platform can be configured to facilitate the conversion of a defaulted ban to a charitable donation for the benefit of the lender(s) that accepted with respect to the seventh transfer funds module,

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

Any publications, patents, and applications mentioned in this specification are herein incorporated by reference.

What is claimed is:

1. A peer-to-peer borrowing and lending lender's marketplace platform comprising:
(a) a first identification module for a borrower to enter identification information, wherein the identification information comprises name and financial information pertaining to the borrower;
(b) a second loan request module for a lender to create a loan request, wherein the loan request comprises loan request information including one or more loan terms;
(c) a third marketplace module for presenting marketplace information, the marketplace information comprising the identification information and the loan request information;
(d) a fourth loan review module for the borrower or other borrowers to accept or request modification of the loan request, wherein if there is a request for modification of the loan request it results in a new loan request by a borrower;
(e) a fifth loan review module for the lender to accept or request modification of any new loan request by a borrower, wherein if there is a request for modification of the new loan request by a lender it results in a modified loan request by the lender;
(f) a sixth promissory note module for the creation of a promissory note for loan requests, new loan requests by a borrower, and modified loan requests by the lender that have been accepted by the borrower or one of the other borrowers and the lender; and
(g) a seventh transfer funds module for the transfer of the loan amount from the lender that accepted in subpart (f) to the borrower that accepted in subpart (f).

2. The peer-to-peer borrowing and lending lender's marketplace platform of claim 1, wherein the third marketplace module provides for filtering by the lender or other lenders for types of identification information and/or loan request information.

3. The peer-to-peer borrowing and lending lender's marketplace platform of claim 1, wherein the third marketplace module provides for filtering the information shown to the borrower or other borrowers concerning the lender.

4. The peer-to-peer borrowing and lending lender's marketplace platform of claim 1, wherein the platform filters loan requests for selected and/or overlapping loan request information.

5. The peer-to-peer borrowing and lending lender's marketplace platform of claim 1, wherein the platform filters borrower information comprising identification information from the borrower and/or other borrowers that has been processed through a predictive algorithm to make a recommendation as to the borrower's fitness for a loan.

6. The peer-to-peer borrowing and lending lender's marketplace platform of claim 1, wherein the platform provides for multiple lenders to each accept a portion of the loan requests, enter into promissory notes, and transfer a portion of loan amounts so that each of the multiple lenders do not take on all of the risk of the borrower defaulting on the loan.

7. The peer-to-peer borrowing and lending lender's marketplace platform of claim 1, wherein the platform provides for lenders to filter for particular identification information and/or loan request information and make multiple loans across multiple borrowers to diversify lenders' risk of borrowers defaulting on their loans.

8. The peer-to-peer borrowing and lending lender's marketplace platform of claim 1, wherein the platform provides for the third marketplace module to be bypassed and instead the platform directly links borrowers and lenders.

9. The peer-to-peer borrowing and lending lender's marketplace platform of claim 1, wherein borrowers and/or lenders bypass the third marketplace module and instead use the platform to directly link borrowers and lenders.

10. The peer-to-peer borrowing and lending lender's marketplace platform of claim 1, wherein the platform is publicly available to groups, networks, borrowers and/or lenders on the internet.

11. The peer-to-peer borrowing and lending lender's marketplace platform of claim 1, wherein the platform is privately available to groups, networks, borrowers and/or lenders by invitation only.

12. The peer-to-peer borrowing and lending lender's marketplace platform of claim 1, wherein multiple platforms are connected and identification information and loan request information is shared across the multiple platforms.

13. The peer-to-peer borrowing and lending lender's marketplace platform of claim 1, wherein if the borrower defaults on a loan, the platform facilitates the conversion of the loan to a charitable donation for the benefit of the lender that accepted with respect to the seventh transfer funds module.

14. A peer-to-peer borrowing and lender borrower's and lender's marketplace platform comprising:
(a) a first identification information module for a borrower to enter identification information, wherein the identification information comprises name and financial information pertaining to the borrower;
(b) a second loan request module for the borrower and/or a lender to create a loan request, wherein the loan request comprises loan request information including one or more loan terms;
(c) a third marketplace module for presenting marketplace information, the marketplace information comprising the identification information and the loan request information;
(d) a fourth loan review module for any lenders or any borrowers to accept or request modification of the loan request, wherein if there is a request for modification of the loan request it results in a new loan request by any lender or any borrower;
(e) a fifth loan review module for any borrower or any lenders to accept or request modification of any new loan request by any lender or any borrower, wherein if there is a request for modification of the new loan request by any lender or any borrower it results in a modified loan request by any borrower or any lender;
(f) a sixth promissory note module for the creation of a promissory note for loan requests, new loan requests by any lender or any borrower, and modified loan requests by any borrower or any lender that have been accepted by any borrower and any lender; and
(g) a seventh transfer funds module for the transfer of the loan amount from any lender that accepted in subpart (f) to the borrower that accepted in subpart (f).

15. The peer-to-peer borrowing and lending borrower's and lender's marketplace platform of claim 14, wherein the third marketplace module provides for filtering by any lender for types of identification information and/or loan request information.

16. The peer-to-peer borrowing and lending borrower's and lender's marketplace platform of claim 14, wherein the third marketplace module provides for filtering the information shown to any borrower concerning any lender.

17. The peer-to-peer borrowing and lending borrower's and lender's marketplace platform of claim 14, wherein the platform filters loan requests for selected and/or overlapping loan request information.

18. The peer-to-peer borrowing and lending borrower's and lender's marketplace platform of claim 14, wherein the platform filters borrower information comprising identification information from the borrower and/or other borrowers that has been processed through a predictive algorithm to make a recommendation as to the borrower's fitness for a loan.

19. The peer-to-peer borrowing and lending borrower's and lender's marketplace platform of claim 14, wherein the platform provides for multiple lenders to each accept a portion of the loan requests, enter into promissory notes, and transfer a portion of loan amounts so that each of the multiple lenders do not take on all of the risk of the borrower defaulting on the loan.

20. The peer-to-peer borrowing and lending borrower's and lender's marketplace platform of claim 14, wherein the platform provides for any lender to filter for particular identification information and/or loan request information and make multiple loans across multiple borrowers to diversify any lender's risk of borrowers defaulting on their loans.

21. The peer-to-peer borrowing and lending borrower's and lender's marketplace platform of claim 14, wherein the platform provides for the third marketplace module to be bypassed and instead the platform directly links borrowers and lenders.

22. The peer-to-peer borrowing and lending borrower's and lender's marketplace platform of claim 14, wherein borrowers and/or lenders bypass the third marketplace module and instead use the platform to directly link borrowers and lenders.

23. The peer-to-peer borrowing and lending borrower's and lender's marketplace platform of claim 14, where the platform is publicly available to groups, networks, borrowers and/or lenders on the internet.

24. The peer-to-peer borrowing and lending borrower's and lender's marketplace platform of claim 14, where the platform is privately available to groups, networks, borrowers and/or lenders by invitation only.

25. The peer-to-peer borrowing and lending borrower's and lender's marketplace platform of claim 14, wherein multiple platforms are connected and identification information and loan request information is shared across the multiple platforms.

26. The peer-to-peer borrowing and lending borrower's and lender's marketplace platform of claim 14, wherein if the borrower defaults on a loan, the platform facilitates the conversion of the loan to a charitable donation for the benefit of the lender that accepted with respect to the seventh transfer funds module.

27. A peer-to-peer borrowing and lending borrower's marketplace platform comprising:
(a) a first identification information module for a borrower to enter identification information, wherein the identification information comprises name and financial information pertaining to the borrower;
(b) a second loan request module for the borrower to create a loan request, wherein the loan request comprises loan request information including one or more loan terms;
(c) a third marketplace module for presenting marketplace information, the marketplace information comprising the identification information and the loan request information;
(d) a fourth loan review module for one or more lenders to accept or request modification of the loan request, wherein if there is a request for modification of the loan request it results in a new loan request by a lender;
(e) a fifth loan review module for the borrower to accept or request modification of any new loan request by a lender, wherein if there is a request for modification of the new loan request by a borrower it results in a modified loan request by the borrower;
(f) a sixth promissory note module for the creation of a promissory note for loan requests, new loan requests by a lender, and modified loan requests by the borrower that have been accepted by the borrower and at least one lender; and
(g) a seventh transfer funds module for the transfer of the loan amount from the at least one lender that accepted in subpart (f) to the borrower that accepted in subpart (f).

28. The peer-to-peer borrowing and lending borrower's marketplace platform of claim 27, wherein the third marketplace module provides for filtering by the one or more lenders for types of identification information and/or loan request information.

29. The peer-to-peer borrowing and lending borrower's marketplace platform of claim 27, wherein the third marketplace module provides for filtering the information shown to the borrower concerning the one or more lenders.

30. The peer-to-peer borrowing and lending borrower's marketplace platform of claim 27, wherein the platform filters loan requests for selected and/or overlapping loan request information.

31. The peer-to-peer borrowing and lending borrower's marketplace platform of claim 27, wherein the platform filters borrower information comprising identification information from the borrower and/or other borrowers that has been processed through a predictive algorithm to make a recommendation as to the borrower's fitness for a loan.

32. The peer-to-peer borrowing and lending borrower's marketplace platform of claim 27, wherein the platform provides for multiple lenders to each accept a portion of the loan requests, enter into promissory notes, and transfer a portion of loan amounts so that each of the lenders do not take on all of the risk of the borrower defaulting on the loan.

33. The peer-to-peer borrowing and lending borrower's marketplace platform of claim 27, wherein the platform provides for a lender to filter for particular identification information and/or loan request information and make multiple loans across multiple borrowers to diversify the lender's risk of borrowers defaulting on their loans.

34. The peer-to-peer borrowing and lending borrower's marketplace platform of claim 27, wherein the platform provides for the third marketplace module to be bypassed and instead the platform directly links the borrower and one or more lenders.

35. The peer-to-peer borrowing and lending borrower's marketplace platform of claim 27, wherein the borrower and/or lenders bypass the third marketplace module and instead uses the platform to directly link the borrower and one or more lenders.

36. The peer-to-peer borrowing and lending borrower's marketplace platform of claim 27, where the platform is publicly available to groups, networks, borrowers and/or lenders on the internet.

37. The peer-to-peer borrowing and lending borrower's marketplace platform of claim 27, where the platform is privately available to groups, networks, borrowers and/or lenders by invitation only.

38. The peer-to-peer borrowing and lending borrower's marketplace platform of claim 27, wherein multiple such platforms are connected and identification information and loan request information is shared across the multiple platforms.

39. The peer-to-peer borrowing and lending borrower's marketplace platform of claim 27, wherein if the borrower defaults on a loan, the platform facilitates the conversion of the loan to a charitable donation for the benefit of the at least one lender that accepted with respect to the seventh transfer funds module.
